(19) United States
(12) Patent Application Publication
(10) Pub. No.: US 2008/0300016 A1
(43) Pub. Date: Dec. 4, 2008

(54) AURAL FEEDBACK APPARATUS FOR USER CONTROLS

(75) Inventor: Sean Michael Nickel, Monroeville, PA (US)

Correspondence Address: WOOD, HERRON & EVANS, LLP, 2700 CAREW TOWER, 441 VINE STREET, CINCINNATI, OH, 45202, US

(73) Assignee: VOCOLLECT, INC., Pittsburgh, PA (US)

(21) Appl. No.: 11/756,329

(22) Filed: May 31, 2007

(51) Int. Cl. H04Q 7/20; G10L 13/00

(52) U.S. Cl. 455/556.2; 704/258

(57) ABSTRACT

A device having a processing unit with a processor and controls disposed on the device. The controls are operable for controlling the processing unit and operation of the device. The controls include at least a first button with capacitive sensing. The first button is operable to generate a first indication to a user when touched and further operable to interact with the processing unit to execute a function when depressed.

### FIELD OF THE INVENTION

This invention relates generally to portable or mobile computer terminals and more specifically to mobile terminals having speech functionality for executing, directing, and assisting tasks using voice or speech.

### BACKGROUND OF THE INVENTION

Wearable, mobile and/or portable computers or terminals are used for a wide variety of tasks. Such mobile computers allow the workers or users using or wearing them (“users”) to maintain mobility, while providing the worker with desirable computing and data-processing functions. Furthermore, such mobile computers often provide a communication link to a larger, more centralized computer system that directs the activities of the user and processes any user inputs, such as collected data. One example of a specific use for a wearable/mobile/portable computer is a voice-directed system that involves speech and speech recognition for interfacing with a user to direct the tasks of a user and collect data gathered during task execution.

An overall integrated system may utilize a central computer system that runs a variety of programs, such as a program for directing or assisting a user in their day-to-day tasks. A plurality of mobile computers is employed by the users of the system to communicate (usually in a wireless fashion) with the central system. The users perform manual tasks according to voice instructions and information they receive through the mobile computers, via the central system. The mobile computer terminal also allow the users to interface with the central computer system using voice, such as to respond to inquiries, obtain information, confirm the completion of certain tasks, or enter data.

In one embodiment, mobile computers having voice or speech capabilities are in the form of separate, wearable units. The computer is worn on the body of a user, such as around the waist, and a headset device connects to the mobile computer, such as with a cord or cable or possibly in a wireless fashion. In another embodiment, the mobile computer might be implemented directly in the headset. In either case, the headset has a microphone for capturing the voice of the user for voice data entry and commands. The headset also includes one or more ear speakers for both confirming the spoken words of the user and also for playing voice instructions and other audio that are generated or synthesized by the mobile computer. Through the headset, the workers are able to receive voice instructions or questions about their tasks, to receive information about their tasks, ask and answer questions, report the progress of their tasks, and report working conditions, for example.

The mobile speech computers provide a significant efficiency in the performance of the workers tasks. Specifically, using such mobile computers, the work is done virtually hands-free without equipment to juggle or paperwork to carry around. However, while existing speech systems provide hands-free operations, they also have various drawbacks associated with their configuration.

One drawback with current systems is the controls on the mobile computer. There are generally three ways to operate the controls, including stopping the task and looking at the controls, feeling around the controls for textures or features or simply operating the controls to see what happens. For example, in a speech system, a typical adjustment for a worker may be adjusting the volume to the associated headset using volume control buttons as the worker moves from one location in a warehouse to another. To look at the controls, the worker may have to shift the mobile computer which may be worn about waist level on a belt or other article of clothing and divert their eyes from the task at hand to look at the control buttons. In the case of a headset computer, the worker may actually have to take the headset off.

Alternatively, feeling around for certain shapes or textures requires knowledge of the terminal. More experienced workers familiar with the mobile computer may be able to select the proper control button by counting the buttons from left to right. This method, though, requires familiarity with the mobile computer as well as feeling around on the device to find a reference button. However, the option of experimentally trying buttons to see what happens is not a particularly desirable tactic.

Accordingly, there is a need, unmet by current and mobile devices, such as mobile computers, to address the issues noted above. There is particularly an unmet need in the area of control for mobile devices used for eyes-free, speech-directed work.

### BRIEF DESCRIPTION OF THE DRAWINGS

The accompanying drawings, which are incorporated in and constitute a part of this specification, illustrate embodiments of the invention and, together with a general description of the invention given above and the Detailed Description given below, serve to explain the invention.

FIG. 1 illustrates a perspective view of a worker using a mobile device and headset according to an exemplary embodiment of the invention;

FIG. 2 is a perspective view of one embodiment of a mobile device for practicing the invention;

FIG. 2A shows a detailed portion of the controls of the portable mobile device of FIG. 2;

FIG. 3 is a diagrammatic representation of the controls on a mobile device of the invention;

FIG. 4 is a diagrammatic representation of an alternate embodiment of a mobile device of the invention; and

FIG. 5 is a flowchart showing a method for identifying a button with capacitive sensing.

### DETAILED DESCRIPTION

The invention addresses the problems with the prior art by providing an aural feedback apparatus for user controls of a device. In one embodiment, a device, such as a portable computer, has a processing unit with processor and controls disposed on the surface, which are operable for controlling the processing unit and the operation of the device. The controls include at least one button or other control mechanism with capacitive sensing. The button is operable to generate a first indication, such as an audible indication, to a user when touched and is further operable to interact with the processing unit to execute a function when depressed or otherwise engaged. The device may be in the form of a mobile, portable or wearable computer that is configured for wireless communications to communicate with a central processor. Although, the invention is not limited and might be used on other devices that utilize headsets or speakers worn by a user. Therefore, while the disclosed exemplary embodiments illustrate the invention in a mobile or wearable computer device, the invention is not so limited. The user controls on the device that are configured with capacitive sensing and an audible indication facilitates easy identification of control buttons without a user having to look directly at the controls. Likewise, easy identification allows the user to concentrate on the task at hand rather than on the controls, thus, increasing efficiency and safety.

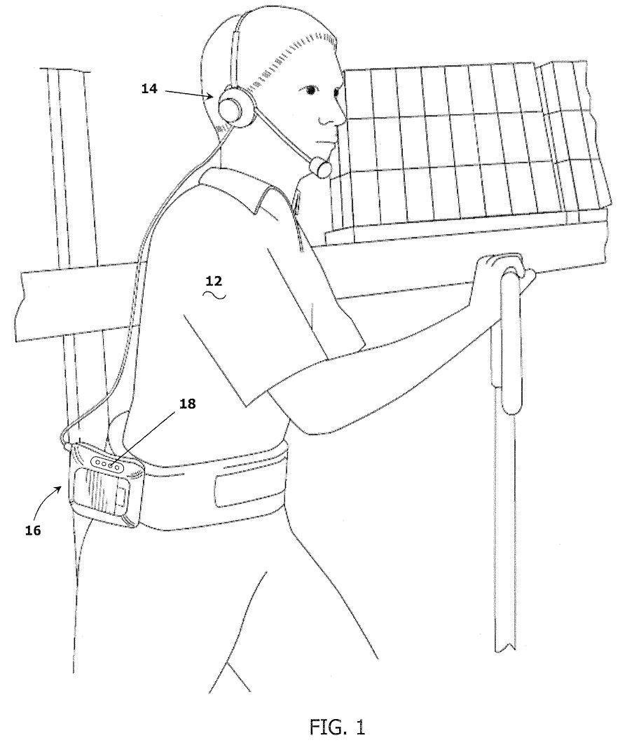

Turning now to the drawings, wherein like numbers denote like parts throughout the several views, FIG. 1 illustrates a user 12, such as a worker, with a device configured as a wearable mobile computer 16 with an associated headset 14. The current figures illustrate a separate portable computer and headset. However, as noted above, the computer might be implemented in a headset. For example, the invention might be used in a headset, such as that shown in U.S. patent application Ser. No. 11/347,979 filed Feb. 6, 2006, which application is incorporated herein by reference.

Instructions that the worker 12 receives from the mobile computer through the headset 14 may be related to any number of voice-directed work tasks. The mobile computer 16 has a control panel 20 with control buttons 18 disposed on the surface with which the worker 12 may control functions of the mobile computer 16. These adjustments may include increasing or decreasing the volume, turning the device on and off, or replaying or pausing an instruction to the worker 12, for example. Other control functions might also be provided. Although FIG. 1 illustrates a headset that is connected by wire to computer 16, a wireless headset connection might also be utilized.

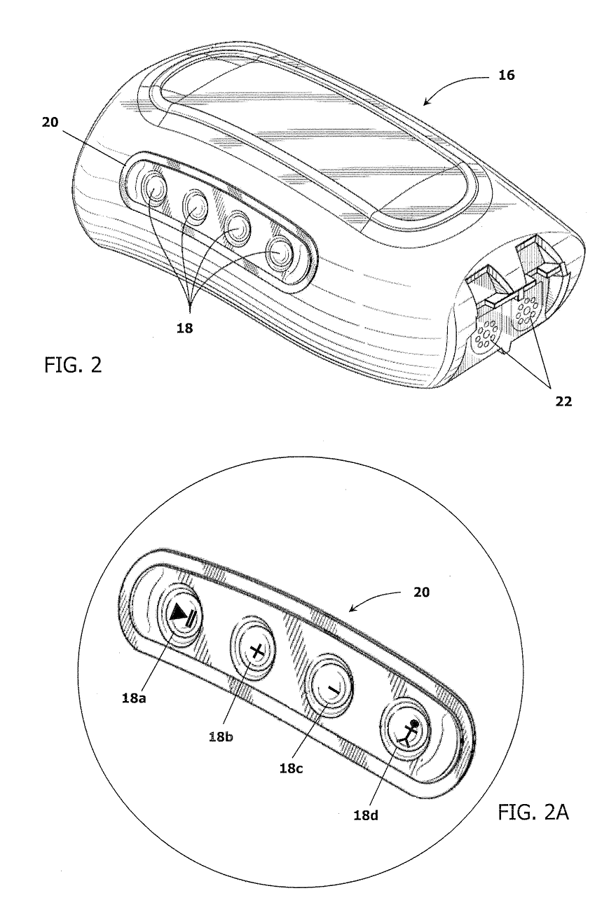

Referring now to FIG. 2, the mobile computer 16 has ports 22 to which a peripheral device, such as the headset 14, or other device may connect in order to provide communication with a central computer (not shown) by the worker 12 through the mobile computer. A control panel 20 is disposed on the surface of the mobile computer 16 in a position so as to be readily available to the worker 12 to control the mobile computer 16. The buttons or other actuators 18 on the control panel 20 may contain individual graphic symbols that visually indicate the function of the button 18, as can be seen in FIG. 2A. For example, volume buttons 18b, 18c may contain symbols indicating volume up (+) and volume down (−) that the worker 12 may use to increase or decrease the volume of the headset speaker(s). Other buttons may include symbols for a replay or pause function 18a or for a power button (on/off) 18d. While buttons are illustrated in the exemplary embodiment, other types of control actuation, such as knobs or levers might also be used, as long as the capacitive features of the invention might be incorporated thereon.

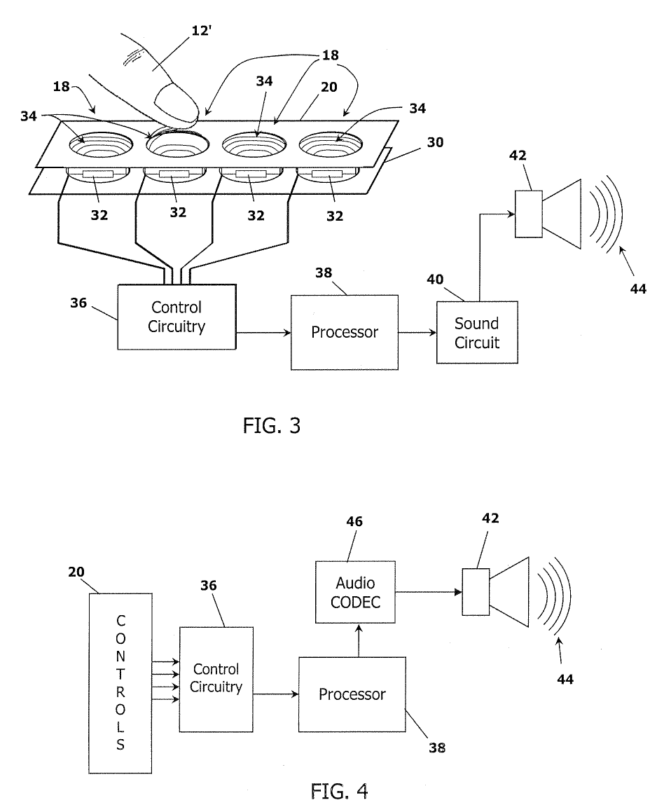

In accordance with one aspect of the invention, in addition to visual indications on the buttons 18 on the control panel 20, the control buttons 18 also are equipped with capacitive sensing. Capacitive sensing may be used to indicate that a particular button 18 has been touched by a user 12, such as by the finger 12′ of the user. Once the mobile computer senses that a particular control button 18 has been touched, it sends an audible or aural feedback to the user, such as a sound or speech, through the speaker(s) of the headset 14. FIG. 3 illustrates one embodiment of a device, such as a mobile computer, for implemental the invention. The control buttons 18 are positioned on a first layer 19 that sits over an electrode layer 30. The electrode layer 30 contains electrodes 32 that are positioned beneath respective buttons 18 and are operably coupled to control circuitry 36 in the mobile computer 16 or other device. A processor 38, or other processing circuitry, is coupled to the control circuitry and is operable to cause the generation of a tone or other sound through a sound circuit 40. The sound is then available for delivery to a speaker 42, such as an external speaker in a headset 14. Although the exemplary embodiments of the invention illustrate headset speakers, the invention might also produce a feedback sound through an internal speaker of the device 16. In one embodiment, the electrodes 32 generate electric fields 34 above each of the respective buttons 18. When a user's finger 12′ touches one of the buttons 18, the electric field 34 above that button 18 is disrupted as illustrated in FIG. 3. The disruption of the electric field causes a change in capacitance detected by the electrode 32 and electrically communicated to control circuitry 36, which is connected to the electrodes 32 in the electrode layer 30.

When the control circuitry 36 detects the capacitive change caused by the disruption of the electric field 34, the control circuitry 36 then sends an electrical signal to the processor 38 indicating which of the buttons 18 has been touched. The processor may then generate, and use the sound circuit 40 to generate, a particular sound or tone that is unique to a particular button 18. The tone or sound is electrically transmitted to speaker 42, such as a speaker in the headset 14, that may then produce an audible indication 44 of the tone to the user 12. In accordance with one aspect of the invention, each button may have its own unique sound or tone associated therewith. From the audible indication or feedback 44, the user 12 may easily audibly identify which of the buttons 18 they have touched. Once the user 12 has determined that they have found the correct control button 18, the user 12 may then depress the button or otherwise activate the control device, which causes the processor 38 to operate the mobile computer or other device 16 to perform the control function associated with that button 18. Therefore, the control circuitry 36 is configured and is appropriately coupled with the control buttons 18 so that the control circuitry will know when a user is touching a button but not pressing it, and when a user is pressing the button to activate a function.

In other embodiments, the audible indication 44 sent to the speaker 42 may be replaced by speech. An alternate embodiment utilizing speech may be seen in FIG. 4. In this embodiment and similar to the embodiment in FIG. 3, a user 12′ touches controls 20 on the mobile computer 16 which in turn disrupts an electric field 34 above the control button 18. The disruption of the electric field 34 causes a capacitive change detected by the electrode 32 in the electrode layer 30. This change in capacitance is electrically communicated to control circuitry 36. The control circuitry 36 then electrically communicates with the processor 38 indicating which of the control buttons 18 has been touched by the user 12′. The processor 38 then selects a speech pattern or words, which are sent to an audio CODEC decoder 46, and turned into speech that is then sent to the speaker 42. The result is audible speech 44′ that may be heard by the user 12. Again, the speaker 42 may be part of the headset 14 worn by the user 12, or in other embodiments may exist on the mobile computer 16 or be a separate, stand alone device.

The speech patterns selectable by the processor 38 may be in the form of a pre-recorded voice that is stored in the mobile computer 16. In other embodiments, the speech patterns may be generated by a synthesized voice from data that may also be stored in the mobile computer 16. The types of speech that may be output through the speaker 42 may indicate the function of the button, for example, by the phrases volume up, volume down, pause, replay, etc.

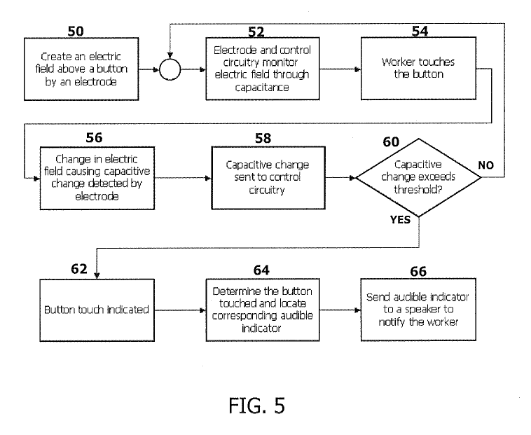

Referring now to FIG. 5, a method for detecting a button touch, in accordance with the invention, might involve a methodology that prevents inadvertent triggering of the audible feedback or indicator. As shown in the flowchart, an electric field, in some embodiments, is created above a button by an electrode beneath the button as noted in block 50. The electrode and control circuitry monitor the electric field through a capacitance as noted in block 52. When a user touches the button (block 54), the user, acting as a ground, causes a disruption in the electric field that causes a change in capacitance. This capacitive change is detected by the electrode (block 56). The capacitive change detected by the electrode is electrically communicated to the control circuitry as noted in block 58. The control circuitry may be configured to check the capacitive change detected by the electrode against some threshold value, as noted in decision block 60. For example, there might be a capacitance change level threshold that might be utilized to determine if there is an engagement of the button by a user, i.e., when the change level exceeds the threshold. Alternatively, there might be a time threshold to determine if the capacitance change exists for a certain amount of time or a duration beyond the threshold time. If the value of the capacitive change or the duration of the change does not exceed the specific threshold value (NO branch of decision block 60), then the electrode and the control circuitry continue to monitor the electric field through capacitance in block 52. Therefore, if a user's touch inadvertently brushes past the control buttons 18, audible indication may not result. Therefore false indications may be avoided. If, however, the capacitive change level or duration does exceed the specific threshold value (YES branch of decision block 60), then a button touch is indicated block 62. Once the button touch has been indicated, a determination is made as to which button was touched and a corresponding audible indicator is located for that specific button (block 64). As described above, the audible indicator may consist of an audible tone, a pre-recorded speech pattern or phrase, or a synthesized speech pattern or phrase, among others. Once the audible indicator has been determined and located, that audible indicator is sent to a speaker to notify the worker in block 66.

While the embodiments above have been illustrated using a capacitive sensing method which is determined by generating an electric field and sensing disturbances in the electric field, a person skilled in the art will recognize that any method of capacitive sensing may be utilized in place of the electric fields in the embodiments shown. Other embodiments may utilize capacitive matrix sensing as well as other techniques and still be within the scope of the invention. Similarly, the audio CODEC module for the speech synthesis may be replaced by any other module suitable for changing electrical signals into speech which may be then sent to a speaker as would be apparent to one skilled in the art.

While the present invention has been illustrated by the description of the embodiments thereof, and while the embodiments have been described in considerable detail, it is not the intention of the application to restrict or in any way limit the scope of the appended claims to such detail. Additional advantages and modifications will readily appear to those skilled in the art. Therefore, the invention in its broader aspects is not limited to the specific details or representative apparatus and method, and illustrative examples shown and described. Accordingly, departures may be made form such details without departure from the spirit or scope of applicant's general inventive concept.

What is claimed is:

1. A device comprising:
a processor; and
controls disposed on the device and operable for controlling the processor and operation of the device, the controls including at least a first control actuator for controlling a function of the device,
the first control actuator having capacitive sensing and operable to generate a first indication to a user of the function controlled by the actuation and further operable to interact with the processor to execute the function of the device when actuated.

2. The device of claim 1, wherein the device is a mobile computer.

3. The device of claim 1, wherein the device is configured for wireless communications with a central system.

4. The device of claim 1, wherein the first control actuator includes a button.

5. The device of claim 1, wherein the first control actuator with capacitive sensing comprises:
a first layer; and
an electrode layer containing at least one electrode, disposed below the first layer.

6. The device of claim 5 further comprising:
control circuitry connected to the electrode layer and configured to sense a capacitive change in an electric field of the electrode.

7. The device of claim 1, wherein a symbol is displayed on the first control actuator indicating a function of the first control actuator.

8. The device of claim 6, wherein the control circuitry is further configured to register a touched condition when at least one of the capacitive change level or duration exceeds a threshold value.

9. The device of claim 1, wherein the controls further comprise at least a second control actuator with capacitive sensing operable, when touched, to generate a second indication to a user of the function controlled by the second actuator, and further operable to interact with the processor to execute another function of the device when depressed.

10. The device of claim 1, wherein the second indication is different from the first indication.

11. The device of claim 1, wherein the first indication is an audible indicator.

12. The device of claim 11 further comprising a speaker and wherein the audible indicator is presented to the user through the speaker.

13. The device of claim 11 further comprising a headset and wherein the audible indicator is presented to the user through the headset.

14. The device of claim 11, wherein the audible indication includes a tone signal.

15. The device of claim 11, wherein the audible indication includes speech.

16. The device of claim 15, wherein the speech is indicative of the function controlled by the first control actuator.

17. The device of claim 15, wherein the speech is a pre-recorded voice message.

18. The device of claim 15, wherein the speech is synthesized voice.

19. A method for providing feedback to a user regarding the controls for a device, the method comprising:
providing a first control actuator for the device that controls a function of the device;
providing a capacitive field proximate to the first control actuator;
sensing a capacitive change in the capacitive field caused by the touch of a user; and
in response to the capacitive change, providing a first indication to a user of the function controlled by the actuator.

20. The method of claim 19, wherein providing a first indication includes providing an audible indicator to a user.

21. The method of claim 20, wherein the device has a speaker and wherein the audible indication is provided to a user through the speaker.

22. The method of claim 20, wherein the device has a headset and wherein the audible indication is provided to a user through the headset.

23. The method of claim 20, wherein the audible indication includes a tone signal.

24. The method of claim 20, wherein the audible indication includes speech.

25. The method of claim 24, wherein the speech is indicative of the function controlled by control actuator.

26. The method of claim 21, wherein the speech is a pre-recorded voice.

27. The method of claim 21, wherein the speech is synthesized voice.

28. The method of claim 19 further comprising:
providing a first layer on an external surface of the device; and
providing an electrode layer containing at least one electrode, disposed below the first layer, the electrode layer providing a capacitive field proximate the first layer.

29. The method of claim 19 further comprising:
providing a second control actuator with a capacitive field proximate thereto and sensing a capacitive change in the field; and
in response to the capacitive change, providing a second indication of the function controlled by the second actuator.

30. The method of claim 29 wherein the first indication is different from the second indication.

31. A computer comprising:
a processor; and
controls disposed on the computer for controlling the processor and operation of the computer, the controls including at least a first control actuator for controlling a function of the computer,
the first control actuator having capacitive sensing and operable to generate a first indication to a user of the function controlled by the actuation and further operable to execute the function of the computer when actuated.

32. The computer of claim 31, wherein the computer is configured for wireless communications with a central system.

33. The computer of claim 31, wherein the control circuitry is further configured to register a touched condition when at least one of the capacitive change level or duration the capacitive change exceeds a threshold value.

34. The computer of claim 31, wherein the first indication is an audible indicator.

35. The computer of claim 34 further comprising a speaker and wherein the audible indicator is presented to the user through the speaker.

36. The computer of claim 34 further comprising a headset and wherein the audible indicator is presented to the user through the headset.

37. The computer of claim 36, wherein the computer is implemented into the headset.

38. The computer of claim 34, wherein the audible indication includes a tone signal.

39. The computer of claim 34, wherein the audible indication includes speech.

40. The computer of claim 39, wherein the speech is indicative of the function controlled by the first control actuator.

41. The computer of claim 39, wherein the speech is at least one of a pre-recorded voice message or synthesized voice.

42. A headset comprising:
a processor; and
controls disposed on the headset for controlling the processor and operation of the headset, the controls including at least a first control actuator for controlling a function of the headset,
the first control actuator having capacitive sensing and operable to generate a first indication to a user of the function controlled by the actuation and further operable to execute the function of the headset when actuated.

43. The headset of claim 42, wherein the first indication is an audible indicator.

44. The headset of claim 42 further comprising a speaker and wherein the audible indicator is presented to the user through the speaker.

45. The headset of claim 42, wherein the audible indication includes a tone signal.

46. The headset of claim 42, wherein the audible indication includes speech.

47. The headset of claim 46, wherein the speech is at least one of a pre-recorded voice message or synthesized voice.
